(19) United States
(12) Patent Application Publication
(10) Pub. No.: US 2017/0346905 A1
(43) Pub. Date: Nov. 30, 2017

(54) METHOD OF TRANSMITTING DATA BETWEEN A SERVER AND AN ELECTRONIC UNIT FOR CONTROL OF A HOME AUTOMATION INSTALLATION

(71) Applicant: OVERKIZ, Metz-Tessi (FR)

(72) Inventor: Sylvain POGNANT, Seynod (FR)

(73) Assignee: OVERKIZ, Metz-Tessi (FR)

(21) Appl. No.: 15/539,890

(22) PCT Filed: Dec. 23, 2015
(86) PCT No.: PCT/FR2015/053740

§ 371 Date: Jun. 26, 2017

(30) Foreign Application Priority Data
Dec. 24, 2014 (FR) 14/63300

(51) Int. Cl. H04L 29/08; H04L 12/28; H04L 29/06; H04L 29/12; H04L 9/08

(52) U.S. Cl. CPC H04L 67/141; H04L 69/18; H04L 61/256; H04L 12/2807; H04L 9/0894; H04L 63/0227

(57) ABSTRACT

Method of transmitting data between a server and an electronic unit for control of a home automation installation. The invention relates to a method of transmitting data between a server (S) and an electronic control unit (U) of a home automation installation (I) comprising the following steps: —a first step of reception (E5) by the electronic control unit (U) of a message requesting opening of connection (Mopen) originating from the server (S) according to a first communication protocol (P1); —a step of establishment (E6) of a connection (Cnx) to the server (S) on the initiative of the electronic control unit (U) according to a second connection protocol (P2); —a second step of reception (E8) by the electronic control unit (U) of a downgoing message (MRp) originating from the server (S) according to the second communication protocol (P2). The invention relates also to a server and an electronic control unit implementing the method.

### TECHNICAL FIELD

The present invention concerns a method for data transmission between a server and an electronic control unit of a home automation installation.

### BACKGROUND

It is known to proceed to exchanges of data between a server and a plurality of electronic control units of home automation installations. Each electronic control unit of a home automation installation is disposed on a private network, whose access is generally protected by a firewall. It may be desirable to proceed to these exchanges of data in particular to operate a remote control of the installations by the server, for example in the case where the server receives instructions from a user interface enabling the user to remotely control his installation.

Consequently, the exchange of data between the server and all the electronic control units must take into account the presence of this firewall. In particular, the establishment of a connection at the initiative of a server external to the private network is conventionally prohibited by a firewall or may be made difficult by the use of a network address translation (NAT) mechanism.

According to a first possibility, a specific configuration of the firewall may be performed in order to enable the establishment of a connection at the initiative of the server. Nonetheless, it appears that this imposes an intervention on each firewall and an authorization to perform said intervention.

According to a second possibility, a connection mechanism at the initiative of the electronic unit may be used, the connections established in this manner being held by the server in order to convey the data from the server to the electronic control unit. Nonetheless, it appears that this second possibility leads to a considerable use of resources on the server which must keep the data relating to all the connections corresponding to each electronic unit.

### BRIEF SUMMARY

The present invention aims to solve all or part of the aforementioned drawbacks.

To this end, the present invention concerns a method for data transmission between a server and an electronic control unit of a home automation installation comprising the following steps:
a first reception step according to a first communication protocol by the electronic control unit a connection open request message coming from the server;
a step of establishing a connection to the server at the initiative of the electronic control unit according to a second connection protocol;
a second reception step by the electronic control unit a downlink message coming from the server according to the second communication protocol;
the first protocol being an connectionless protocol, and the second protocol corresponding to an connected mode communication.

Thanks to the dispositions according to the invention, the establishment of the connection according to the second communication protocol is carried out at the initiative of the electronic control unit to the server, subsequently to the connection open request formulated by the server according to the first protocol.

Thus, the establishment of the connection will be enabled by the firewall, because it is at the initiative of the electronic control unit. Afterwards, the server can use the connection according to the second protocol to communicate the useful data corresponding to its connection open request in the downlink message.

These dispositions allow performing the communication of information between the server and the electronic unit in a top-down manner by only using a connection establishment at the initiative of the electronic control unit.

Moreover, the use of two communication protocols allows using a simpler first protocol involving a low use of resources on the server, and an connected mode second protocol involving a more considerable use of resources only when information must be communicated by the server.

In particular, the first protocol is an connectionless protocol. The second protocol corresponds to an connected mode communication.

The first protocol used may be of various types allowing not to be subjected to the constraints imposed by the firewall.

According to one embodiment, the first communication protocol is a protocol comprising sending of a message from the server to the electronic control unit, in particular an SMS message.

According to another embodiment, the first protocol corresponds to a datum supplied in an audio and/or video stream, for example an MPEG stream.

It should be noted that the term uplink concerns the messages transmitted by the electronic control unit to the server and that the term downlink concerns the messages transmitted by the server to the electronic control unit.

According to an aspect of the invention, the method comprises a first step of periodic transmission of an uplink message according to the first communication protocol by the electronic control unit toward the server; the first reception step of a connection open request message comprising a reception step according to the first protocol at least one downlink message subsequent to the first transmission step.

The electronic unit being disposed on a private network whose access is conventionally protected by a firewall, the emission of an uplink message allows the server to respond to this message by a downlink message which can reach the electronic unit because it will be considered as a response to the uplink message.

Thus, the periodic sending of an uplink message offers time windows to the server to communicate connection open requests. By choosing a periodicity of the messages smaller than the time window enabled by the firewall to respond to an uplink message, it is possible to permanently maintain a possibility of communication from the server to the electronic control unit, that is to say an open communication channel.

Moreover, a periodic sending allows determining the state of the network link between the electronic control unit and the server.

According to an aspect of the invention, the method comprises, prior to the first reception step of a connection open request, a reception step according to the first communication protocol by the electronic control unit a downlink message coming from the server corresponding to an accessibility response.

The prior step and the second step may be simultaneous, successive and/or have a temporal overlap period. In particular, the prior reception step corresponds to the reception of an accessibility response according to a first delay after the transmission step, in order to maintain the possibility of reception of a second frame according to a second delay. The second step corresponds to the reception of a connection request during said second delay.

Indeed, it appears that the operation of a conventional firewall may prevent the passage of a downlink message to the extent that the latter is received beyond a first delay after sending of an uplink message. Also in a conventional manner, to the extent that a first downlink message is received, a second longer delay is allotted for receiving one or several other downlink messages.

According to an aspect of the invention, the method comprises a step of monitoring at least one reception delay of a downlink message coming from the server subsequently to the first transmission step, the triggering of a new first transmission step being triggered if the at least one reception delay has elapsed.

These dispositions allow holding communication windows open so that the server could communicate.

According to an aspect of the invention, the method comprises a step of transmitting an uplink message toward the server according to the second communication protocol subsequently to the connection establishment step and prior to the second reception step of a downlink message;

In response to the uplink message of the electronic control unit, the server may communicate the useful data corresponding to its connection open request in a response in the form of a downlink message according to the second protocol.

These dispositions allow carrying out the communication of information between the server and the electronic control unit in a top-down manner by using a mode of requests and responses in the form of uplink and downlink messages at the initiative of the electronic control unit.

As example, a HTTP or HTTPS type communication may be implemented.

It should be noted that not all uplink and downlink messages necessarily contain useful data. Thus, in an exchange of request and response in the form of an uplink or downlink message, only the response or only the request can contain useful data.

According to an aspect of the invention, the method comprises a step of releasing and/or accepting the release of the connection according to the second communication protocol after a determined number of transmissions of uplink messages and/or receptions of downlink messages according to the second communication protocol or after a determined delay after the communication establishment step.

Thanks to these dispositions, the resources used on the server to hold the sessions' data are limited, because the number of concurrent connections is small since the connections are closed after an exchange of some information.

This communication mode is adapted to home automation applications in which a large number of electronic control units are connected to a server with a low volume of data to exchange with the latter.

The release of the connection may be carried out at the initiative of the server or of the electronic control unit, as the case may be.

According to one embodiment, there is provided one single exchange according to the second protocol comprising an application uplink message and an application downlink message before release of the connection.

According to another embodiment, one single application downlink message is received before release of the connection.

According to an aspect of the invention, the method comprises a step of transmitting an encryption key by the electronic control unit to the server, so as to enable a signature of the uplink and/or downlink messages according to the first communication protocol and/or according to the second communication protocol.

These dispositions allow performing a signature of the exchanges between the server and the electronic control unit in order to authenticate the two entities in presence, namely the server and the electronic control unit.

According to an aspect of the invention, the method comprises a step of receiving an invalid or expired key indication coming from the server, and in response a new step of transmitting an encryption key.

These dispositions allow reestablishing a communication via the first communication mode in case of expiration of the encryption key.

The present invention also concerns a method for data transmission between a server and an electronic control unit of a home automation installation comprising the following steps:
a first step of transmitting according to a first communication protocol by the server a connection open request message toward the electronic control unit;
a step of accepting the establishment of a connection by the server at the initiative of the electronic control unit according to a second connection protocol;
a second step of transmitting according to the second communication protocol by the server a downlink message toward the electronic control unit according to the second communication protocol.

According to an aspect of the invention, the method comprises a first step of periodic reception of an uplink message according to the first communication protocol by the server coming from the electronic control unit; the first step of transmitting a connection open request message comprising a step of transmitting at least one downlink message subsequent to the first reception step.

According to an aspect of the invention, the method comprises, prior to the first step of transmitting a connection open request, a prior step of transmitting by the server toward the electronic control unit a downlink message corresponding to an accessibility response.

According to an aspect of the invention, the method comprises a step of receiving an uplink message by the server coming from the electronic control unit according to the second communication protocol subsequently to the connection establishment acceptance step and prior to the second step of transmitting a downlink message.

According to an aspect of the invention, the method comprises a step of releasing and/or accepting the release of the connection according to the second communication protocol after a determined number of receptions of uplink messages and/or transmissions of downlink messages according to the second communication protocol or after a determined delay after the communication establishment acceptance step.

According to an aspect of the invention, the first communication protocol is the UDP protocol.

According to an aspect of the invention, the second communication protocol is the TCP protocol.

According to another aspect of the invention, the first and/or the second protocol may be of the Raw IP type or another protocol on top of IP.

The present invention also concerns a computer program product comprising program code portions for the execution of the steps of a method for data transmission by an electronic control unit as previously described.

The present invention also concerns an electronic control unit of a home automation installation comprising a processing unit arranged to contain and execute the computer program product, the electronic control unit further comprising at least one communication interface intended for the command and/or the control of at least one actuator, in particular of a movable element of a building, or of another equipment which can be commanded or controlled electrically or electronically, such as for example an alarm system, or of at least one sensor, and a communication interface intended for the communication according to the first communication protocol or the second communication protocol with a server.

The present invention also concerns a computer program product comprising program code portions for the execution of the steps of a method for data transmission by a server as previously described.

The present invention also concerns a server for remote command and/or control of at least one electronic control unit of a home automation installation comprising a processing unit arranged to contain and execute the computer program product, the server further comprising at least one communication interface intended for the communication according to the first communication protocol or the second communication protocol with at least one electronic control unit.

According to an aspect of the invention, the server may also comprise a communication interface intended for the communication with a user interface.

These dispositions enable a remote control of the home automation installation by the user, and sending of orders via the server to the electronic control unit, or obtaining data on the state of the installation.

For example, the user interface may be formed by a web server communicating with a user terminal, for example a computer, a mobile phone or a tablet.

The present invention also concerns a distributed system comprising at least one server and a plurality of electronic control units arranged to communicate with the server so as to implement the method as previously described.

### BRIEF DESCRIPTION OF THE DRAWINGS

The invention will be better understood from the detailed description which is exposed hereinbelow with reference to the appended drawing in which:

FIG. 1 is a diagram illustrating the structure of a system intended for the implementation of a method for data transmission between a server and a set of electronic control units of home automation installations.

FIG. 2 is a diagram illustrating an implementation of a data transmission method.

FIG. 3 is a diagram illustrating an additional step of the method of FIG. 2.

FIG. 4 is a diagram illustrating the structure of a second system intended for the implementation of a method for data transmission between a server and a set of electronic control units of home automation installations.

### DETAILED DESCRIPTION

In the following detailed description of the figures defined hereinabove, the same elements or the elements filling identical functions may preserve the same references so as to simplify the understanding of the invention.

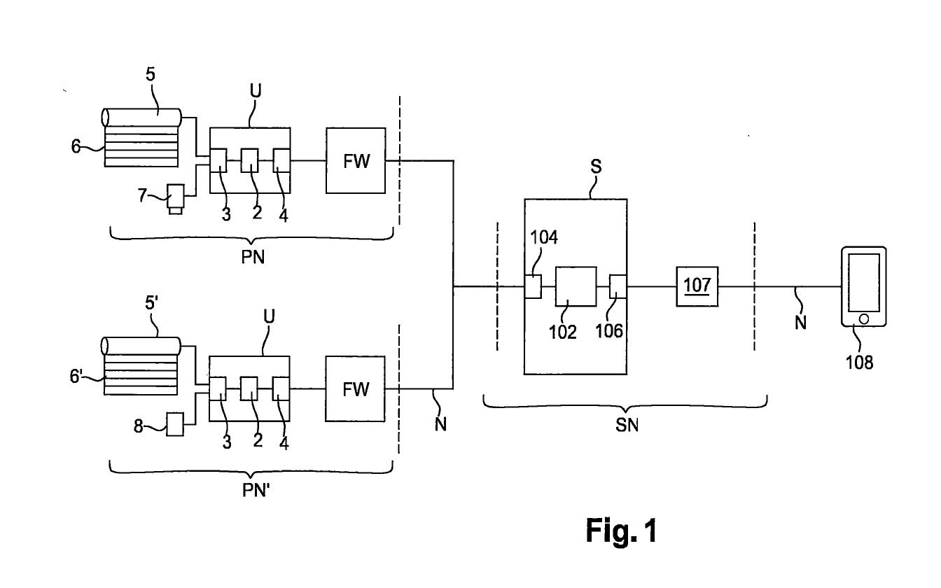

As represented in FIG. 1, a distributed system comprises at least one server S and a plurality of electronic control units U of home automation installations arranged to communicate with the server S so as to implement a data transmission method.

Each electronic control unit of a home automation installation is disposed on a private network PN, PN′, whose access is protected by a firewall FW. The server S is also disposed on a private network NS.

The private networks PN, PN′, SN are linked to a wide area network N, for example the Internet.

In particular, an electronic control unit U of a home automation installation comprises a processing unit 2 arranged to contain and execute a first computer program.

As example, the processing unit 2 comprises a processor, a flash memory for storage as well as a random-access memory, and an Ethernet chip PHY.

The electronic control unit U further comprises at least one communication interface 3 intended for the control/command of actuators of movable elements of a building, of sensors, or still of other electrically or electronically controlled equipment such as an alarm system.

As example, as represented in FIG. 1, the communication interface 3 enables the control and command of at least one actuator 5, 5′ of a movable element of a building, such as for example a rolling shutter 6 or an orientable sunshade 6′ or still the reception of information from a sensor 7 supplying information on the presence of a user or values of the surrounding parameters such as temperature, humidity, luminosity. In the same manner, the interface may enable the control/command of an alarm system 8.

In particular, the communication interface 3 may comprise an Io-homecontrol and/or Zwave and/or WM-Bus radio-frequency chip communicating at a frequency of 868 MHz, and/or an RTS/RTD/RTD+ radio-frequency chip communicating at a frequency of 433 MHz.

Moreover, the electronic control unit U comprises a battery and/or a mains power supply, as well as physical connection ports such as for example USB host, RJ45 and micro-USB.

The electronic control unit U also comprises interface elements such as reset, configuration buttons, tactile buttons for launching scenarios, and/or operation light indicators, such as for example LEDs.

Moreover, the electronic control unit U comprises a communication interface 4 intended for the communication according to the first communication protocol P1 or the second communication protocol P2 with the server S.

The server S which allows the remote command and/or the control of the plurality of electronic control units U of a home automation installation comprises a processing unit 102 arranged to contain and execute a second program.

The server S further comprises at least one communication interface 104 intended for the communication according to the first communication protocol P1 or the second communication protocol P2 with the plurality of electronic control units U.

The server S may also comprise a communication interface 106 intended for the communication with a user interface 107. For example, the user interface 107 may be formed by a web server communicating with a user terminal 108 via the network N, for example a computer, a mobile phone or a tablet.

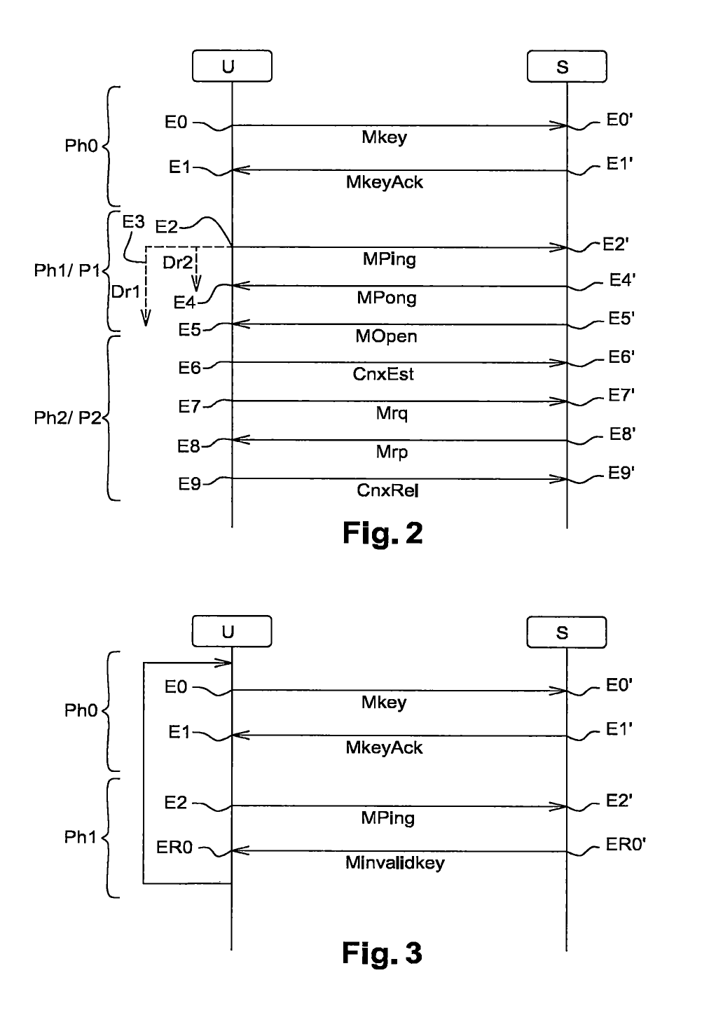

FIG. 2 represents a diagram of the implementation of the data transmission methods executed on the server S and on an electronic control unit U of a home automation installation I.

According to the implementation described in FIG. 2, the method comprises a first phase Ph0 of negotiating a secret key, a second phase Ph1 carried out according to the first communication protocol intended to collect a connection request from the server S and a third phase Ph2 of transmitting data subsequently to the establishment of a connection according to the second communication protocol at the initiative of the electronic control unit.

The secret key negotiation phase Ph0 comprises a step E0 of transmitting an encryption key in a message Mkey by the electronic control unit U to the server S which receives it during a step E0′, so as to enable a signature of the uplink and/or downlink messages according to the first communication protocol P1 and/or according to the second communication protocol P2. In particular, the encryption key may be randomly chosen by the electronic control unit U.

The server acknowledges receipt of the key and validates that it has taken well into account the new key by a downlink message MkeyAck transmitted at a step E1′ which is received by the electronic control unit U during a reception step E1.

The exchanges between the electronic control unit U during the negotiation phase may be carried out according to a communication protocol distinct from or similar to the first communication protocol and the second communication protocol P1 and P2. As example, a HTTPS type protocol may be chosen which allows communicating the key in a secure manner.

It should be noted that this exchange is not carried out frequently, and consequently does not represents significant resources consumption. As example, a periodicity of several days may be provided for the validity of the keys.

The second communication phase Ph1 according to the first protocol P1 comprises a first step E2 of periodic transmission of an uplink message Mping according to the first communication protocol P1 by the electronic control unit U toward the server S which receives it at a step E2′. As example, a periodicity in the range of ten seconds may be provided for the periodicity of the transmission, and in particular in the range of 20 s.

In response to this uplink message, the server S transmits at a step E4′ a downlink message Mpong toward the electronic control unit U which is received at a prior reception step E4 within a first short delay Dr1 after the transmission of the uplink message Mping. As example, the delay Dr1 may be in the range of a few seconds, and in particular in the range of 5 s.

This first downlink message Mpong allows holding the communication channel open during a second delay Dr2 longer than the first delay Dr1. Indeed, it appears that the operation of a conventional firewall may prevent the passage of a downlink message to the extent that the latter is received beyond a first delay after sending an uplink message. Also in a conventional manner, to the extent that a first downlink message is received, a second longer delay is allotted for receiving one or several other downlink messages. In particular, it is possible to choose triggering a new transmission of the message Mping before the expiration of the delay Dr2.

Subsequently, in the case where the server S has useful data DU to transmit to the electronic control unit U, the latter transmits according to the first communication protocol P1 during a step E5′ a connection open request message Mopen, which is received by the electronic control unit U during a step E5.

The second communication phase Ph1 according to the first protocol P1 comprises a step E3 of monitoring a reception delay Dr of a downlink message coming from the server S subsequently to the first transmission step Mping, the triggering of a new first transmission step E2 being carried out if the reception delay has elapsed.

During this phase, the exchanges are signed with the secret key communicated during the first communication phase Ph0.

As illustrated in FIG. 3, during the second communication phase Ph1 according to the first communication protocol P1, the server may carry out a step ER0′ of transmitting an invalid or expired key indication Minvalidkey coming from the server S, and in response a new step of transmitting an encryption key E0. Typically, this situation may intervene during the transmission of an uplink message MPing, the server having noticed that the message has a correct format but is not signed with a valid key. It should be noted that in the case of a restart of the electronic control unit, the first communication phase Ph0 with communication of the key is carried out again.

During the second communication phase Ph1, the first communication protocol may in particular be the UDP protocol.

The third phase Ph2 of the method is carried out subsequently to the reception of the connection open request received by the electronic control unit in the second phase at step E5.

At first, a step E6 of establishing a connection Cnx to the server S which accepts this connection at a corresponding step E6′ is carried out, at the initiative of the electronic control unit U according to a second connection protocol P2. In particular, the communication protocol may be the TCP protocol. In this case, the establishment step E6 may comprise several exchanges between the server and the unit U, and in particular exchanges of connection management messages, such as the messages of the TCP SYN, SYN/ACK, ACK protocol.

Once the connection Cnx is established, a step E7 of transmitting an uplink message MRq is carried out according to the second communication protocol P2 toward the server S which receives this message at a step E7′.

In particular, the message MRq may be a message without any useful data but constituting an uplink message a response to which may be sent by the server.

Thus, the server transmits a downlink message MRp at a transmission step E8′ toward the electronic control unit U. This downlink message contains the useful data DU that the server has to transmit to the electronic control unit.

Subsequently to this exchange, a step E9, E9′ of releasing or accepting the release of the connection Cnx is carried out.

The second used communication protocol may be in particular the TCP protocol. In particular, the exchanges of steps E7/E7′ and E8/E8′ may be carried out in the form of a request and a response according to the HTTPS protocol which uses TCP.

According to variants of implementation, the release of the connection may intervene after several exchanges of uplink messages and/or receptions of downlink messages according to the second communication protocol or even after a determined delay after the communication establishment step E6.

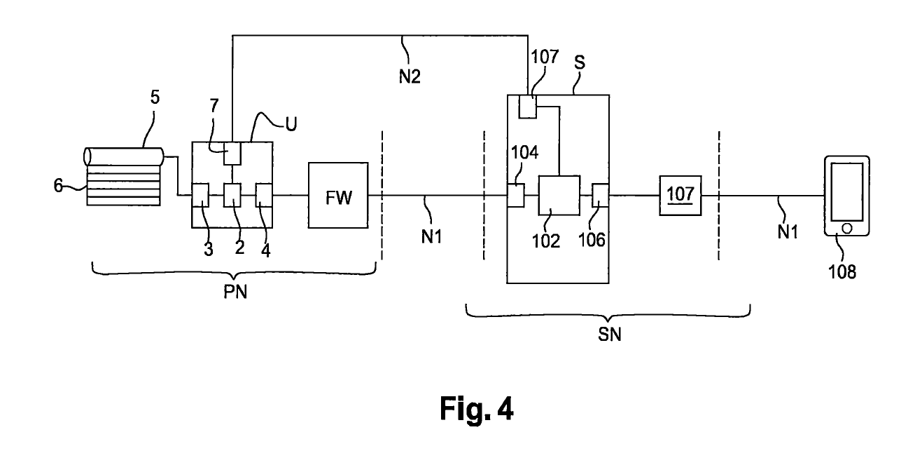

According to a second implementation of a system implementing the invention represented in FIG. 4, the first communication protocol is an SMS-type protocol comprising the sending of a message from the server to the electronic control unit U identified in this case by a telephone number. Thus second protocol is used on a telephone-type network N2, for example a GSM network or wired telephony over Internet, with a feature for managing digital messages.

To this end, the server S comprises a communication interface 107 on the network N2, such as for example a GSM card, just as the electronic control unit, which also comprises a communication interface 7 on the network N2, such as a GSM card or a hardware and software module for telephony over Internet, which may be integrated to the firewall or to the electronic control unit U.

Thus, the exchange according to the first protocol and the step of receiving a connection open request simply corresponds to sending SMS between the server S and the electronic control unit U.

FIG. 4 represents only one electronic control unit, but this second embodiment applies of course to the communication with a multitude of electronic control units.

According to variants of implementation, the first protocol used may be of various types allowing not to be subjected to the constraints imposed by the firewall.

According to a second variant, the first protocol corresponds to a datum supplied in an audio and/or video stream, for example an MPEG stream. According to this variant, the electronic control unit U comprises or is associated to an interface for decoding the corresponding audio and/or video stream.

According to another variant, the first and/or the second protocol may be of the Raw

IP type or another protocol on top of IP.

According to variants of the third communication phase Ph2, it is possible that the application exchanges follow the transactions model, comprising a request and a response. The requests are sent in the form of uplink messages, and the responses in the form of downlink messages. Thus, in an exchange of request and response in the form of an uplink, respectively downlink, message, only the response or only the request can contain useful data. An uplink message and the downlink message transmitted in return may contain useful data which do not necessarily correspond to the same transaction. For example, a current request requiring an application processing is transmitted in the form of an uplink message, and may trigger the transmission of a downlink message without any useful data, or containing useful data relating to a previous request. In the same manner, the application response corresponding to the current request may be sent during a subsequent exchange of uplink message/downlink message. This exchange may comprise an uplink message without any useful data

According to a variant of the third communication phase Ph2, it is possible that subsequently to the establishment of the connection E6, only one downlink message is transmitted by the server S, without transmission of any uplink message by the electronic control unit. In this case, a protocol other than HTTPS may be used, while leaning on the reliable services provided by a transport protocol operating in the connected mode, such as TCP.

It should be noted that the description hereinabove describes methods enabling the transmission of data from the server S to the electronic control unit U.

The data transmission in the direction from the electronic control unit to the server may be carried out for example according to the second communication protocol without difficulty considering that it is possible to directly establish a connection at the initiative of the electronic control unit.

As example, a request and a response according to the HTTPS protocol may be performed, then the established connection is released in order to limit the use of the resources of the server.

### EXAMPLE

We will now describe as example a format of the messages used in the method as previously described according to the first embodiment in the configuration of the system presented in FIG. 1.

In the considered example, the first protocol is the UDP protocol.

The messages are transmitted in UDP datagrams. In particular, a message may correspond to a UDP datagram. The body of the UDP datagram is constituted by one single UTF-8 encoded frame.

The general form of the format of the frames comprises a first block called BODY, a second block SEQUENCE and a last BLOC for SIGNATURE, these blocks being separated by separators / and % as represented hereinbelow:
<BODY>/<SEQUENCE>%<SIGNATURE>

Nonetheless, it should be noted that the message or the frame Minvalidkey or INVALIDKEY has neither a sequence nor a signature, and therefore only the block BODY.

We will detail hereinbelow the different identified blocks.

The block BODY has the following general form:
<TYPE>#<SERIAL>#<TIMESTAMP># . . .

The field TYPE comprises information on the type of message which may be: PING (for a message Mping), PONG (for a message Mpong), OPEN (for a message Mopen), INVALIDKEY (for a message Minvalidkey).

The SERIAL field comprises the serial number of the electronic control unit U.

The field TIMESTAMP comprises a timestamp, for example a Timestamp UNIX corresponding to the number of seconds from EPOCH, calculated by the emitter of the message.

Other fields may be present depending on the type of message as described hereinbelow.

In particular, in the case of a message Mping, transmitted from the electronic control unit U to the server S, the block BODY has the following structure:
PING#<SERIAL>#<TIMESTAMP>#<ACTIVITY_INTERVAL>

The field ACTIVITY_INTERVAL corresponds to the maximum number of seconds between two activities of the electronic control unit U, that is to say a transmission to the server according to the first or second communication protocol.

The electronic control unit U must send a message Mping immediately after its startup and afterwards it must regularly: either emit a new message Mping, or establish a connection Cnx to affirm its presence with the server.

The maximum duration between one of these two activities is:
recovered by the electronic control unit U in its startup configuration;
transmitted by the electronic control unit U in each message Mping to specify to the server that it is the current activity period thereof
may be modified by a message Mpong sent back by the server as described hereinbelow.

In the case of a message Mpong transmitted from the server S to the electronic control unit U, the block BODY has the following structure:
PONG#<SERIAL>#<TIMESTAMP>#<NEW_ACTIVITY_INTERVAL>

The field NEW_ACTIVITY_INTERVAL comprises a new value (in seconds) of the desired activity period.

The server must send back a message Mpong for each message Mping received.

If the value of the activity period of the electronic control unit U is different from that supplied in the message Mpong, the electronic control unit U must update its value accordingly.

In the case of a message Mopen transmitted from the server S to the electronic control unit U, the block BODY has the following structure:
OPEN#<SERIAL>#<TIMESTAMP>

The server sends a message Mopen to the electronic control unit U when it desires that the latter connects to the server as early as possible via the HTTPS channel.

In the case of a message Minvalidkey transmitted from the server S to the electronic control unit U, the block BODY has the following structure:
INVALIDKEY#<SERIAL>#<TIMESTAMP>#<REJECTED_SIGNATURE>

The server sends a message Minvalidkey when it receives a message Mping with a valid format but whose signature is incorrect or when it has exhausted its sequence number source.

When the electronic control unit U receives a message Minvalidkey, a phase of renegotiating a new secret key is carried out with the server S.

The electronic control unit U must verify that REJECTED_SIGNATURE actually corresponds to the signature of the last sent message Mping, otherwise it can silently ignore the message.

The block SEQUENCE corresponds to an integer value (32 bits) representing the sequence number of the transmitted frame.

Each transmitted message must contain a strictly increasing sequence number in order to avoid REPLAY type attacks.

Each actor of the communication (electronic control units and server) has its own sequence counter that it uses to number the message sent thereby.

The first transmitted message must have a sequence number equal to 1.

The next messages must have a strictly increasing sequence number, incremented by 1 at each message (namely 2, 3, 4, 5 . . . ).

The sequence counters must be reset to zero each time a new secret key is negotiated.

Since the UDP protocol does not guarantee the order of arrival of the transmitted packets, the control of the sequence number must appeal to a sliding window mechanism, by applying in particular the following control algorithm:
If the received sequence number is equal to the last received number, it is considered as invalid;
If the received sequence number is strictly greater than the last received number, it is considered as valid; This number then replaces the last received value and the sliding window is shifted to leave room to this new value;
If the received sequence number is strictly lower than the last received number:
   If the difference between the two values is strictly lower than the size of the window
   If the new value does not already appear in the window, the sequence number is considered as valid; the sliding window is shifted to leave room to this new value;
   If the new value already appears in the window, the sequence number is considered as invalid;
   If the difference between the two values is greater than the size of the window; the sequence number is considered as invalid.

The control windows must be reset to zero each time a new secret key is negotiated.

Any message having an invalid sequence number must be silently ignored.

The block SIGNATURE corresponds to a signature of the message, disposed at the end of the message after the separator % in hexadecimal notation.

Each transmitted message must have a signature.

The signature covers the entire content of the message before the separator % excluded. The algorithm and the signature secret key must be negotiated beforehand via a HTTPS channel.

The signature of the messages is systematically verified, except for the messages Minvalidkey. Every message having an invalid signature is silently ignored. The signature of a frame must be verified before verifying the sequence number.

It goes without saying that the invention is not limited to the sole embodiment of these method and system, described hereinabove as example, but it encompasses on the contrary all variants thereof.

1. A method for data transmission between a server and an electronic control unit of a home automation installation comprising the following steps:
a first reception step according to a first communication protocol by the electronic control unit a connection open request message coming from the server;
a step of establishing a connection to the server at the initiative of the electronic control unit according to a second connection protocol;
a second reception step by the electronic control unit of a downlink message coming from the server according to the second communication protocol;
the first protocol being an connectionless protocol, and the second protocol corresponding to an connected mode communication.

2. The method according to claim 1, comprising:
a first step of periodic transmission of an uplink message according to the first communication protocol by the electronic control unit toward the server;
and wherein the first reception step of a connection open request message comprises a reception step according to the first protocol of at least one downlink message subsequent to the first transmission step.

3. The method according to claim 1, comprising, prior to the first reception step of a connection open request:
a prior reception step according to the first communication protocol by the electronic control unit of a downlink message coming from the server corresponding to an accessibility response.

4. The method according to claim 2, comprising a step of monitoring at least one reception delay of a downlink message coming from the server subsequently to the first transmission step, the triggering of a new first transmission step being triggered if the at least one reception delay has elapsed.

5. The method according to claim 1, comprising:
a step of transmitting an uplink message toward the server according to the second communication protocol subsequently to the connection establishment step and prior to the second reception step of a downlink message.

6. The method according to claim 1, comprising a step of releasing and/or accepting the release of the connection according to the second communication protocol after a determined number of transmissions of uplink messages and/or receptions of downlink messages according to the second communication protocol or after a determined delay after the communication establishment step.

7. A method for data transmission between a server and an electronic control unit of a home automation installation comprising the following steps:
a first step of transmitting according to a first communication protocol by the server a connection open request message toward the electronic control unit;
a step (E6′) of accepting the establishment of a connection by the server at the initiative of the electronic control unit according to a second connection protocol;
a second step of transmitting according to the second communication protocol by the server a downlink message toward the electronic control unit according to the second communication protocol.

8. The method according to claim 7, comprising:
a first step of periodic reception of an uplink message according to the first communication protocol by the server coming from the electronic control unit;
and wherein the first step of transmitting a connection open request message comprises a step of transmitting at least one downlink message subsequent to the first reception step.

9. The method according to claim 7, comprising, prior to the first step of transmitting a connection open request:
a prior step of transmitting by the server toward the electronic control unit a downlink message corresponding to an accessibility response.

10. The method according to claim 7, comprising:
a step of receiving an uplink message by the server coming from the electronic control unit according to the second communication protocol subsequently to the connection establishment acceptance step and prior to the second step of transmitting a downlink message.

11. The method according to claim 7, comprising a step of releasing and/or accepting the release of the connection according to the second communication protocol after a determined number of receptions of uplink messages and/or transmissions of downlink messages according to the second communication protocol or after a determined delay after the communication establishment acceptance step.

12. A computer program product comprising program code portions for the execution of the steps of a data transmission method according to claim 1 when said program is executed by a computer.

13. An electronic control unit of a home automation installation comprising a processing unit arranged to contain and execute the computer program product according to claim 12, the electronic control unit further comprising at least one communication interface intended for the command and/or the control of at least one actuator, in particular of a movable element of a building, or of another equipment which can be commanded or controlled electrically or electronically, such as for example an alarm system, or of at least one sensor, and a communication interface intended for the communication according to the first communication protocol or the second communication protocol with a server.

14. A computer program product comprising program code portions for the execution of the steps of a data transmission method according to claim 7 when said program is executed by a computer.

15. A server for remote command and/or control of at least one electronic control unit of a home automation installation comprising a processing unit arranged to contain and execute the computer program product according to the preceding claim, the server further comprising at least one communication interface intended for the communication according to the first communication protocol or the second communication protocol with at least one electronic control unit.
